(19) United States
(12) Patent Application Publication
(10) Pub. No.: US 2014/0253494 A1
(43) Pub. Date: Sep. 11, 2014

(54) METHOD AND DEVICE FOR DETECTING DISPLAY DAMAGE AND RECONFIGURING PRESENTATION DATA AND ACTUATION ELEMENTS

(71) Applicant: MOTOROLA MOBILITY LLC, Libertyville, IL (US)

(72) Inventors: Jun Jiang, Lake Zurich, IL (US); Li Zhuang, Long Grove, IL (US); Sergey A. Kudakov, Arlington Heights, IL (US); Michael F. Olley, Lake Zurich, IL (US)

(73) Assignee: MOTOROLA MOBILITY LLC, Libertyville, IL (US)

(21) Appl. No.: 14/030,241

(22) Filed: Sep. 18, 2013

Related U.S. Application Data
(60) Provisional application No. 61/775,850, filed on Mar. 11, 2013.

(51) Int. Cl. G06F 3/041; G06F 3/048; G06F 3/044

(52) U.S. Cl. CPC G06F 3/0418; G06F 3/044; G06F 3/048
USPC 345/174

(57) ABSTRACT

A method (330) for detecting damage (501) on a display (108) or other touch-sensitive surface is disclosed. A damage detection module (304), operable with a control circuit (301) of an electronic device (100), detects a damaged portion (702) of the display. A presentation adaptation module (305) presents user actuation targets (404) in portions (701) of the display that are complementary to the damaged portion. The presentation adaptation module can optionally present non-interactive presentation data in the damaged portion. The presentation adaptation module may also optionally reconfigure the user actuation targets prior to presenting them on the display.

### BACKGROUND

1. Technical Field

This disclosure relates generally to electronic devices, and more particularly to user input elements for electronic devices.

2. Background Art

“Intelligent” portable electronic devices, such as smart phones, tablet computers, and the like, are becoming increasingly powerful computational tools. Moreover, these devices are becoming more prevalent in today's society. For example, not too long ago a mobile telephone was a simplistic device with a twelve-key keypad that only made telephone calls. Today, “smart” phones, tablet computers, personal digital assistants, and other portable electronic devices not only make telephone calls, but also manage address books, maintain calendars, play music and videos, display pictures, and surf the web.

As the capabilities of these electronic devices have progressed, so too have their user interfaces. Prior art physical keypads having a limited number of keys have given way to sophisticated user input devices such as touch sensitive displays. Touch sensitive displays include sensors for detecting the presence of an object such as a finger or stylus. By placing the object on the touch sensitive surface, the user can manipulate and control the electronic device without the need for a physical keypad.

One drawback to touch sensitive displays is that they can break. Many are manufactured from glass or plastic. Either of these materials is susceptible to breakage. Even the most robust materials, such as thermally tempered glass, can break if the device is dropped or if a sharp object hits the display with the necessary amount of force. Once the display breaks, the electronic device is generally rendered unusable due to the fact that the primary user input has become compromised. It would be advantageous to have a more robust electronic device.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic device configured in accordance with one or more embodiments of the disclosure.

FIG. 2 illustrates an exploded view of one explanatory electronic device configured in accordance with one or more embodiments of the disclosure.

FIG. 3 illustrates a schematic block diagram of one explanatory electronic device configured in accordance with one or more embodiments of the disclosure.

FIG. 4 illustrates one explanatory presentation of both user actuation targets and presentation data on a display of one explanatory device configured in accordance with one or more embodiments of the disclosure.

FIG. 5 illustrates one explanatory electronic device configured in accordance with one or more embodiments of the disclosure after the display has been damaged.

FIG. 6 illustrates one explanatory method of detecting a damaged portion of a touch sensitive display configured in accordance with one or more embodiments of the disclosure.

FIG. 7 illustrates one explanatory method of reconfiguring actuation targets and presentation data in accordance with one or more explanatory methods of the disclosure.

FIG. 8 illustrates another explanatory method of detecting a damaged portion of a touch sensitive display configured in accordance with one or more embodiments of the disclosure.

FIG. 9 illustrates another explanatory method of reconfiguring actuation targets and presentation data in accordance with one or more explanatory methods of the disclosure.

FIG. 10 illustrates one explanatory electronic device configured in accordance with one or more embodiments of the disclosure after the display has been damaged.

FIG. 11 illustrates another explanatory method of reconfiguring actuation targets and presentation data in accordance with one or more explanatory methods of the disclosure.

FIG. 12 illustrates another explanatory method of reconfiguring actuation targets and presentation data in accordance with one or more explanatory methods of the disclosure.

FIG. 13 illustrates another explanatory method of reconfiguring actuation targets and presentation data in accordance with one or more explanatory methods of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DISCLOSURE

Before describing in detail embodiments that are in accordance with the present disclosure, it should be observed that the embodiments reside primarily in combinations of method steps and apparatus components related to detecting damage along a touch sensitive display and reconfiguring actuation targets and presentation data in response to detecting the damage. Any process descriptions or blocks in flow charts should be understood as representing modules, segments, or portions of code that include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

It will be appreciated that embodiments of the disclosure described herein may be comprised of one or more conventional processors and unique stored program instructions that control the one or more processors to implement, in conjunction with certain non-processor circuits, some, most, or all of the functions of the method steps of detecting damage on a touch sensitive display and reconfiguring the same as described herein. The non-processor circuits may include, but are not limited to, processing circuits, driver circuits, signal drivers, clock circuits, power source circuits, and executable code stored in a computer readable medium such as a memory device. As such, these functions may be interpreted as steps of a method to perform display damage detection and display reconfiguration. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present disclosure provide a method, suitable for use with a control circuit operating in an electronic device, of detecting a damaged portion of a touch sensitive display and reconfiguring data presented on the damaged display. This data can include actuation targets configured to receive touch input from a user. The data can further include presentation data. Presentation data differs from actuation targets or actuation data due to the fact that it is non-responsive to touch input. In a virtual keyboard, the data configured to look like a “Q” key would be an example of an actuation target due to the fact that a control circuit operable with the display is configured to register a Q input when the user touches the virtual Q key. By contrast, the background of a webpage being displayed is presentation data or non-interactive data because the control circuit is configured not to take action if a user touches this portion of the presentation data.

In one embodiment, methods described below reconfigure the display by presenting the actuation targets in areas of the display that are not damaged. Said differently, a control circuit can be operable to present the user actuation targets in areas of the display that are complementary to the detected damaged portions. The term “complementary” is used in the set logic sense, i.e., to describe members of a set that are not members of a given subset. When used in terms of the display, with the display being the “set,” the damaged portion would be the given subset. All portions that are not within the damaged portion would comprise the complement of the damaged portion. Accordingly, in one embodiment the control circuit can present data configured to receive touch input along portions of the display that are complementary to the damaged portion, thereby allowing the user to still operate the electronic device. Since presentation data is not configured to receive touch input, in one embodiment the control circuit can then present the non-interactive presentation data along the damaged portion to allow the full display to still be used.

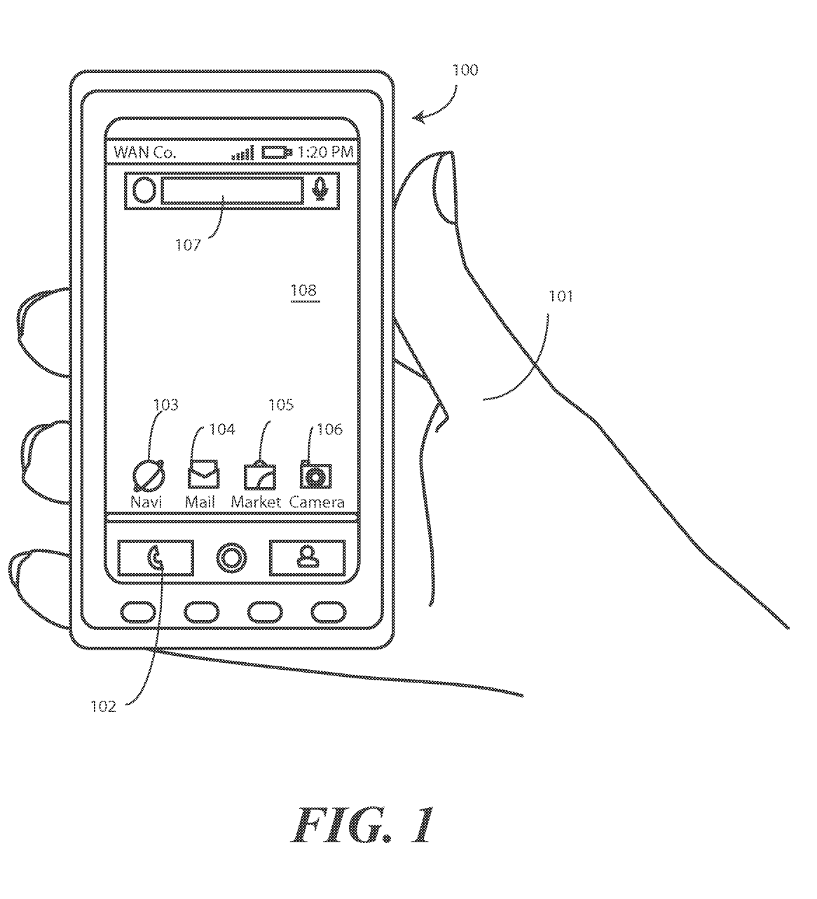

Turning now to FIG. 1, illustrated therein is one embodiment of an electronic device 100 configured in accordance with one or more embodiments of the disclosure. The explanatory electronic device 100 of FIG. 1 is shown as a smart phone for illustrative purposes. However, it will be obvious to those of ordinary skill in the art having the benefit of this disclosure that other electronic devices may be substituted for the explanatory smart phone of FIG. 1. For example, the electronic device 100 may be configured as a palm-top computer, a tablet computer, a gaming device, wearable computer, a media player, or other device.

A user 101 is holding the electronic device 100. The operating system environment, which is configured as executable code operating on one or more processors or control circuits of the electronic device 100, has associated therewith various applications or “apps.” Examples of such applications shown in FIG. 1 include a cellular telephone application 102 for making voice telephone calls, a navigation application 103 configured to provide mapping and navigation information to the user on the display 108 of the electronic device 100, an electronic mail application 104 configured to send and receive electronic mail, a shopping application 105 configured to permit a user to shop for goods and services online, and a camera application 106 configured to capture still (and optionally video) images. An Internet and/or local search application 107 is also provided. The Internet and/or local search application 107 allows a user to search the web or the local device for items like contacts, lists, songs, media, desirous information on persons, places, and things, and so forth. These applications are illustrative only, as others will be obvious to one of ordinary skill in the art having the benefit of this disclosure.

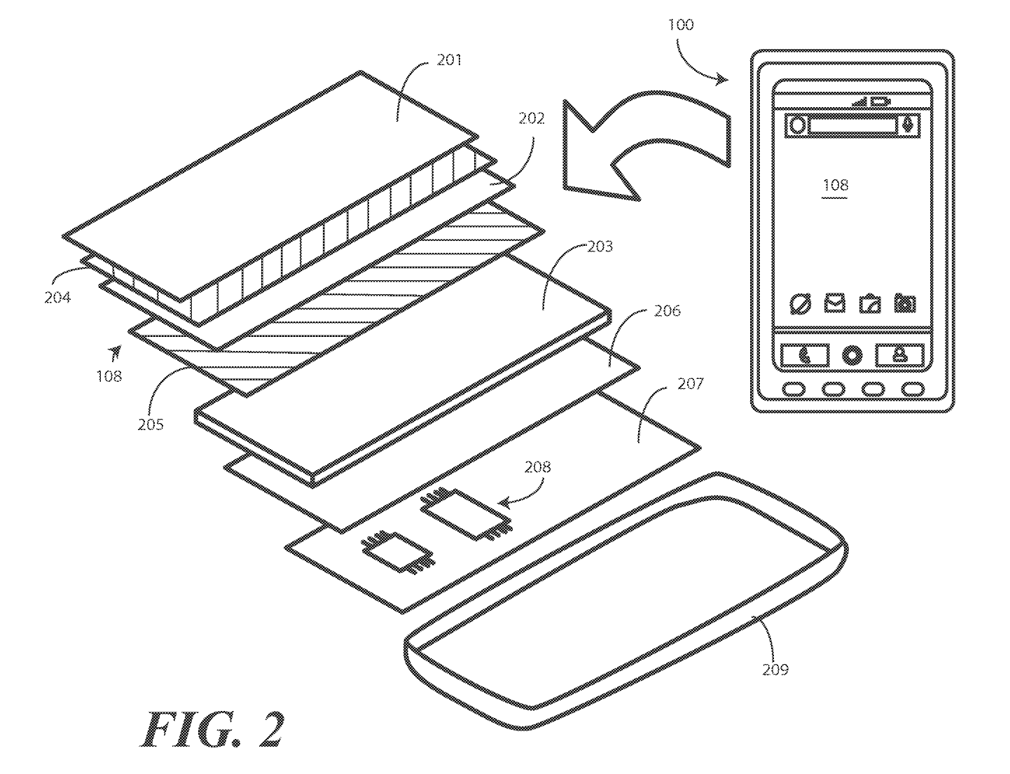

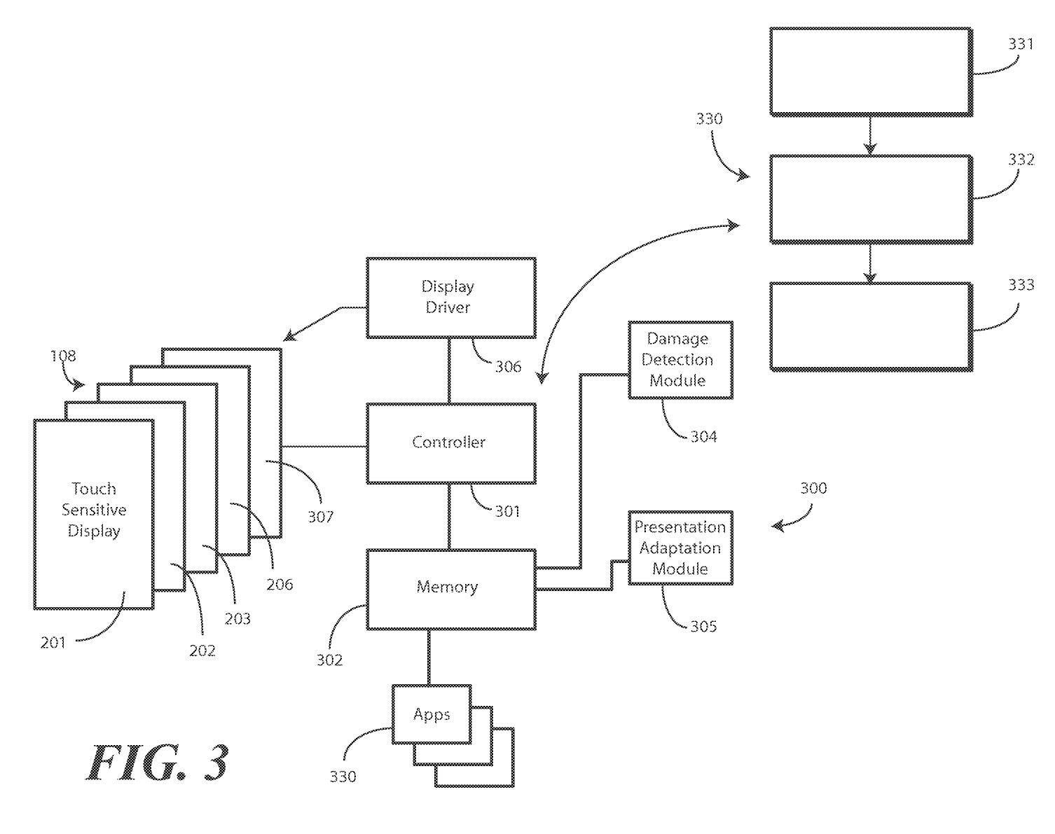

Turning now to FIG. 2, illustrated therein is an exploded view of one embodiment of the electronic device 100. Many of the elements shown in FIG. 2 will be explained in further detail with reference to FIG. 3 below. However, FIG. 2 provides an exploded view to illustrate one explanatory mechanical “stack-up” of how the elements can be arranged within a housing in one embodiment. In this illustrative embodiment, the electronic device 100 includes a display 108 that is touch-sensitive. The illustrative display 108 of FIG. 2 employs a capacitive touch sensor to provide its touch-sensing function. However, it will be clear to those of ordinary skill in the art having the benefit of this disclosure that other touch sensing technologies can be substituted for the capacitive sensor shown in FIG. 2.

Starting from the top of the electronic device 100, a fascia layer 201 is configured to receive touch input from a user. The fascia member 201 spans at least a portion of the electronic device. In one embodiment, the fascia member will span a major face—or a portion thereof—of the electronic device 100. The fascia layer 201 may be manufactured from reinforced glass, plastic, or other suitable materials. In one embodiment, the fascia layer 201 is a rigid fascia member.

Next, the explanatory electronic device 100 includes a capacitive touch sensor layer 202. The capacitive touch sensor layer 202 can be used to determine the position along the display 108 in which a user's finger or stylus makes contact with the display 108. In this illustrative embodiment, the capacitive touch sensor layer 202 is disposed beneath substantially the entire fascia layer 201 such that touch input can be received along substantially the entirety of the display 108. However, in other embodiments, the capacitive touch sensor layer 202 is disposed along only a portion of the fascia layer 201, such as within a predefined user interface region that does not span the entirety of the display 108.

Next, the electronic device 100 includes a display layer 203 for presenting information to a user. In one embodiment, the display layer 203 is a high-resolution LCD display. However, other technologies can be used, including organic LED displays, LED displays, and so forth. One or more layers of adhesive 204,205 can be used to couple the various components of the display 108 together in one or more embodiments. An optional backlight layer 206 can be included where necessary for operation with the display layer 203. For example, if the display layer 203 is a LCD display layer, the backlight layer 206 can project light through pixels of the display layer 203.

A substrate layer 207 may be disposed beneath the display layer 203. The substrate layer 207, which may be a rigid or flexible printed circuit board, accommodates the various electronic circuitry 208 the electronic device 100 uses for operation. For example, a control circuit, display driver circuit, capacitive sensor circuit, and so forth can be included in the electronic circuitry 208. Each of the various layers is then disposed within a housing 209 of the electronic device 100.

Turning now to FIG. 3, illustrated therein is the electronic device 100 shown as a schematic block diagram 300. The schematic block diagram 300 illustrates one embodiment of internal circuitry, software modules, firmware modules, and other components in an electronic device 100 in accordance with embodiments of the disclosure. While this illustrative internal circuitry is directed to a generic electronic device, note that it could be readily adapted to any number of specific devices.

As shown in the schematic block diagram 300, a control circuit 301 is operable with the display 108, which is touch-sensitive in this illustrative embodiment. The control circuit 301, which may be a microprocessor, programmable logic, application specific integrated circuit device, or other similar device, is capable of executing program instructions, such as those shown in method 330. The program instructions may be stored either in the control circuit 301 or in a memory 302 or other computer readable medium operable with the control circuit 301. The memory 302 can also store executable code corresponding to the various applications 303 that are operable on the electronic device 100, such as those described above with reference to FIG. 1. The control circuit 301 is configured, in one embodiment, to operate the various functions of the electronic device 100. The control circuit 301 can execute software or firmware applications stored in memory 302 to provide device functionality.

In one embodiment, the control circuit 301 is configured to be operable with both a damage detection module 304 and a presentation adaptation module 305. The damage detection module 304 and the presentation adaptation module 305 can be configured as executable code, or alternatively may be configured as hardware, such as in programmable logic or other devices incorporated in, substituted for, or operable with the control circuit 301. The control circuit 301, damage detection module 304, and the presentation adaptation module 305 are also configured to be operable with a display driver 306 to effect and control presentation of information on the display 108.

Coupled to, and operable with, the controller is the display 108. As with the embodiment of FIG. 2, the display 108 of FIG. 3 is touch-sensitive and is shown as a plurality of layers. While this is one embodiment of a touch sensitive display, it will be clear to those of ordinary skill in the art having the benefit of this disclosure that embodiments of the disclosure are not so limited. Numerous other touch sensitive surfaces can be substituted without departing from the spirit and scope of the disclosure.

In the illustrative embodiment of FIG. 3, the five layers from FIG. 2 are shown. Starting from the top, a fascia layer 201 is provided. The fascia layer 201 may be manufactured from glass or a thin film sheet, and can serve as a unitary fascia member for the electronic device. As used herein, a “fascia” is a covering or housing, which may or may not be detachable. Suitable materials for manufacturing the cover layer include clear or translucent plastic film, glass, plastic, or reinforced glass. Reinforced glass can comprise glass strengthened by a process such as a chemical or heat treatment. The fascia layer 201 may also include a ultra-violet barrier. Such a barrier is useful both in improving the visibility of display 108 and in protecting internal components of the electronic device.

Beneath the fascia layer 201 is the capacitive touch sensor layer 202. The capacitive touch sensor layer 202, which can be constructed by depositing small capacitive plate electrodes on a transparent substrate, is configured to detect the presence of an object, such as a user's finger or stylus, near to or touching the display 108. Circuitry operable with or disposed within the control circuit 301 is configured to detect a change in the capacitance of a particular plate combination on the capacitive touch sensor layer 202. The capacitive touch sensor layer 202 may be used in a general mode, for instance to detect the general proximate position of an object relative to the touch sensitive display. The capacitive touch sensor layer 202 may also be used in a specific mode, where a particular capacitor plate pair may be detected to detect the precise location of an object along length and width of the touch sensitive display. Note that the capacitive touch sensor layer 202 is a particular implementation of an electromagnetic field sensor, and other types of electromagnetic field sensors, such as a magnetic field sensor, can replace the capacitive field sensor.

Note that while the capacitive touch sensor layer 202 and the fascia layer 201 are shown as separate layers in FIGS. 2 and 3 for illustrative purposes, in many embodiments they will be integrated into a single element to achieve a thinner overall form factor of the electronic device 100. Accordingly, in one embodiment the capacitive touch sensor layer 202 is integrated with the fascia layer 201 by depositing the capacitor plate electrodes of the capacitive touch sensor layer 202 directly upon the fascia layer 201. For example, indium tin oxide defining the capacitor plate electrodes can be laminated directly to the underside of the fascia layer 201.

Beneath the capacitive touch sensor layer 202, whether integrated into the fascia layer 201 or separate, in one embodiment is a display layer 203. Note that while the capacitive touch sensor layer 202 can be adjacent to the display layer 203, in one embodiment there is a gap disposed between the capacitive touch sensor layer 202 and the display layer 203. In another embodiment, a layer of adhesive (205) is disposed between the capacitive touch sensor layer 202 and the display layer 203.

In one embodiment, the display layer 203 comprises a high-resolution display. An electroluminescent layer or light-emitting diode (LED) backlight layer 206 may be disposed beneath the display layer 203 and may be configured to project light through the display layer 203 so as to backlight the display layer 203. The display layer can adaptively present text, graphics, user actuation targets, data, and controls along the display 108.

An optional haptic layer 307, which was not shown in FIG. 2, may be disposed beneath the backlight layer 206. The haptic layer 307 can be configured to provide a pseudo-tactile feedback in response to user actuation of virtual buttons, user actuation targets, or user input controls presented on the 108. The haptic layer 307 can simulate conventional physical keys by delivering a tactile response to the body of the electronic device.

In one embodiment, the haptic layer 307 includes a transducer configured to provide a sensory feedback when a user actuates a virtual key. In one embodiment, the transducer is a piezoelectric transducer configured to apply a mechanical “pop” to the housing (209) of the electronic device 100, or alternatively the display 108 of the electronic device 100, that is strong enough to be detected by the user. Thus, the haptic layer 307—where used—can provide sensory feedback to the user, thereby making the display 108 react like a conventional keypad.

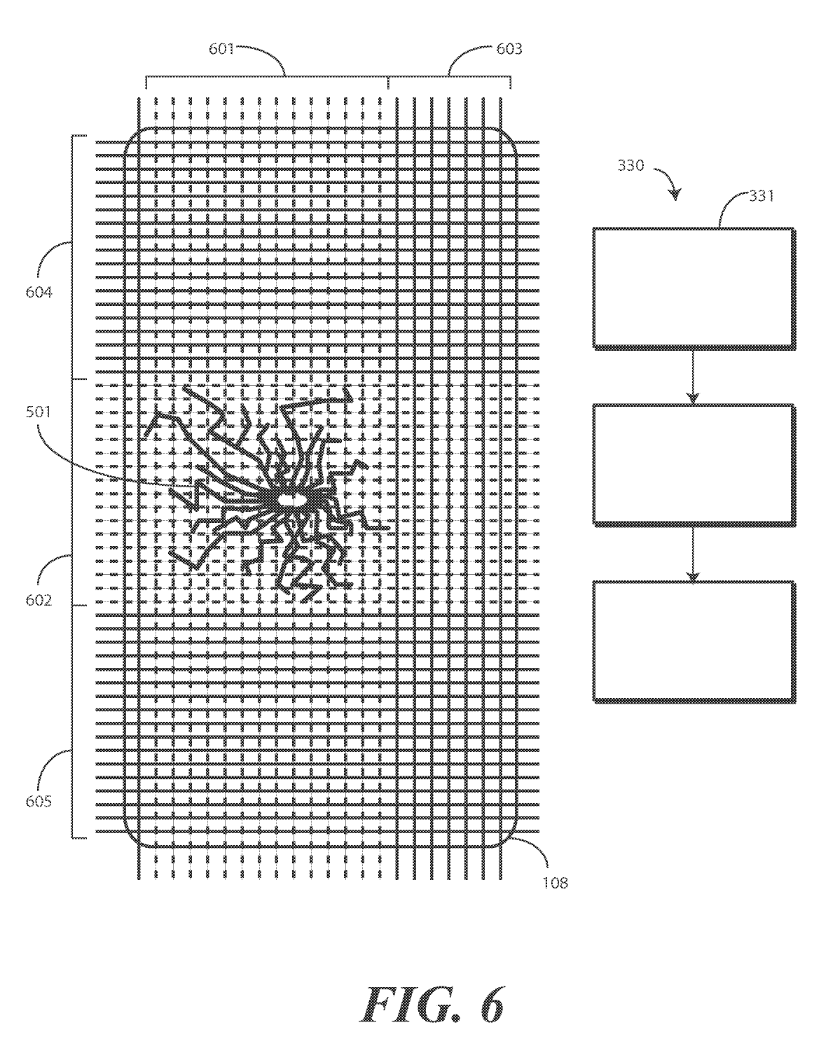

Turning now to the modules, the damage detection module 304 is configured to detect a damaged portion of the display layer 203. While this will be explained in more detail with respect to the embodiments shown in FIGS. 6, 8, and 10-11 below, in one embodiment the damage detection module 304 is configured to detect one or more of the capacitive plate electrodes of the capacitive touch sensor layer 202 that are not functioning to detect user input. For example, when the fascia layer 201 is damaged by dropping, hitting, or otherwise impacting the display 108, it is frequently the case that the capacitive plate electrodes of the capacitive touch sensor layer 202 will become damaged. These capacitive plate electrodes can be cut, bent, shorted together, or otherwise rendered inoperable for detecting changes in the electric field between those capacitive plate electrodes. As will be described in FIGS. 6, 8, and 10-11 below, the damage detection module 304 can also be configured to detect what portion(s) of the display 108 are damaged as well. In one or more embodiments, the damage will illustratively be described as including a fracture of the fascia layer 201. However, it will be clear to those of ordinary skill in the art having the benefit of this disclosure that other types of damage can render capacitive plate electrode pairs inoperable as well.

Once the damage detection module 304 has detected a damaged portion of the display 108, the presentation adaptation module 305 is configured to present user actuation targets and other user input data in areas of the display 108 that are complementary to the damaged portion. Accordingly, data configured as a user actuation target that a user touches to “do something” are presented on the display 108 where the damage is not. Thus, the user (101) can still use the non-damaged portions of the display 108 for touch input.

In one or more embodiments, the presentation adaptation module 305 can optionally present non-interactive presentation data beneath the damaged portions of the display. While the damaged portion of the fascia layer 201 may render some of the capacitive plate electrodes being inoperable, it may not affect the operation of the display layer 203 of the backlight layer 206. Moreover, the damage to the fascia layer 201 may not substantially affect the visibility of data being presented through the damage. Accordingly, the presentation adaptation module 305 can, in some embodiments, be configured to present non-interactive data along the damaged portions of the display 108. “Non-interactive” presentation data simply presents information to the user and is not a dedicated actuation target.

In one or more embodiments, the presentation adaptation module 305 can optionally be configured to reconfigure operating characteristics of the electronic device 100 in response to damage to the display 108 as well. For example, the presentation adaptation module 305 can be configured to recalibrate gains and thresholds of the capacitive touch sensor layer 202 to compensate for damaged detected by the damage detection module 304. The presentation adaptation module 305 can be configured to resize, scale, reposition, and relocate information presented on the 108.

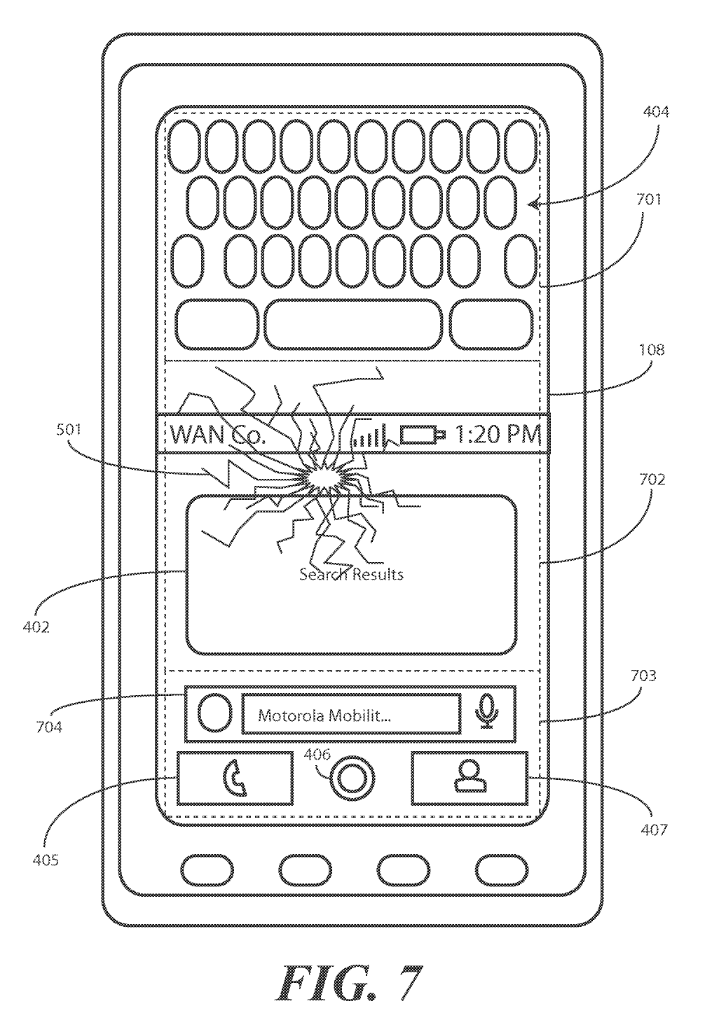

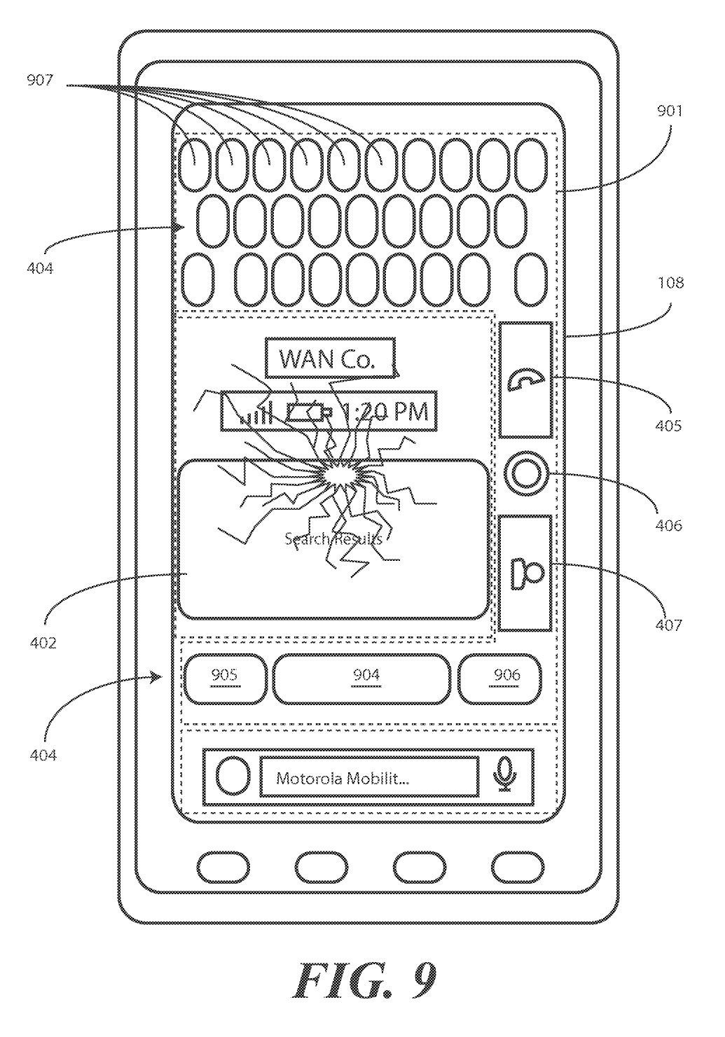

The damage detection module 304 and the presentation adaptation module 305 can, in one or more embodiments, work with the control circuit 301 to execute a method 330 configured in accordance with one or more embodiments of the disclosure. Illustrating by example, at step 331, the damage detection module 304, operating in conjunction with the control circuit 301, can detect a damaged portion of the display 108, which in this illustrative embodiment is touch-sensitive. Once this step 331 is complete, at step 332, the presentation adaptation module 305, also operating with the control circuit 301, can present user actuation targets in areas of the display 108 that are complementary to the damaged portion detected at step 331. As will be shown in FIGS. 7 and 9 below, step 331 can optionally include reconfiguring how the user actuation targets are arranged prior to presenting them in the areas that are complementary to the damage. At optional step 333, the presentation adaptation module 305 can present at least some of the non-interactive presentation data in the damaged portion detected at step 331.

In another embodiment of the invention, step 331 can include detecting damage to a touch sensitive user input of the electronic device 100. In this illustrative embodiment, the touch sensitive user input would include the capacitive touch sensor layer 202 and the display layer 203 working together to form a touch-sensitive display. However, the touch sensitive user input could alternatively include a touch pad of an electronic device not configured as a display, a touch-sensitive surface of a device housing, and so forth.

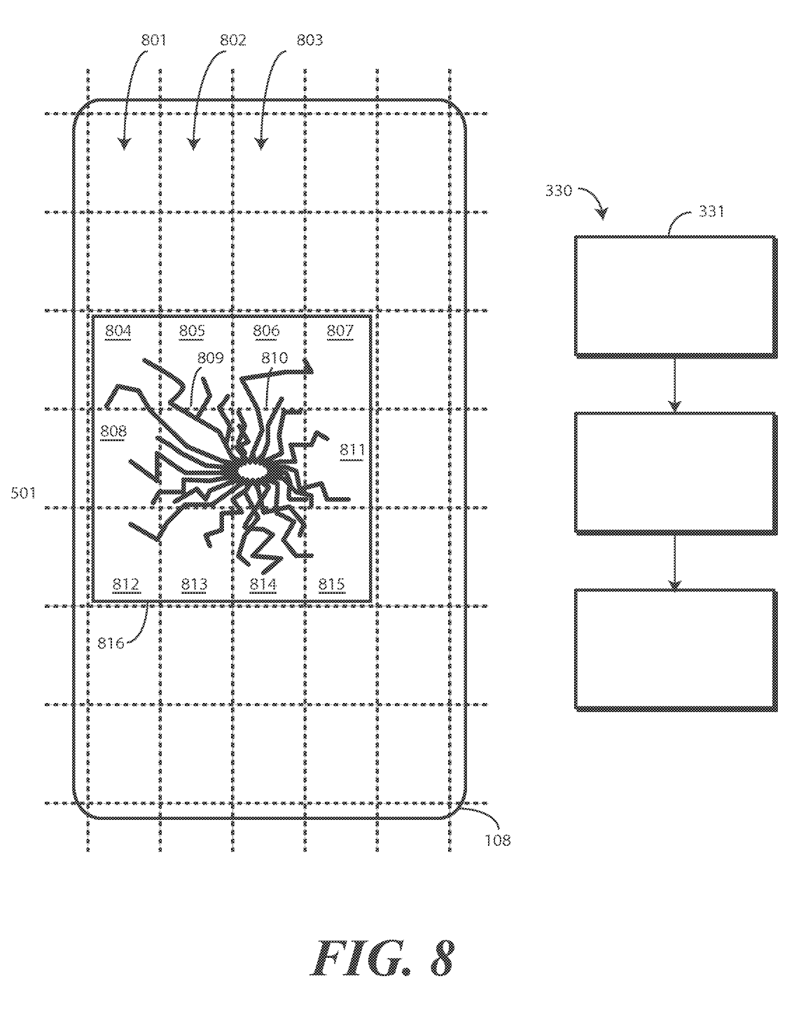

Step 331 can also include detecting a damage perimeter that circumscribes the damage along the touch sensitive user input. One example of how this can be accomplished, shown in more detail below in FIG. 6, is for the damage detection module 304 to detect individual capacitor plate pairs of the capacitive touch sensor layer 202 that are inoperable. The next closest capacitor plate pairs could then be used to define the perimeter circumscribing the damage. In another embodiment, the damage detection module 304 can determine the damage perimeter by identifying inoperable groups of capacitor plate pairs. In another embodiment, shown in more detail in FIG. 8, is to divide the display 108 into zones and determine which zones include inoperable capacitor plate pairs and in which zones all of the capacitor plate pairs are operative. The boundaries of the “good” zones can be used to construct a perimeter circumscribing the damage. Other methods for detecting the damage perimeter will be obvious to those of ordinary skill in the art having the benefit of this disclosure.

Step 332 can then include presenting user actuation targets on the touch sensitive user input in areas that are only outside the damage perimeter. Optional step 333 can then include presenting at least some non-interactive presentation data within the damage perimeter.

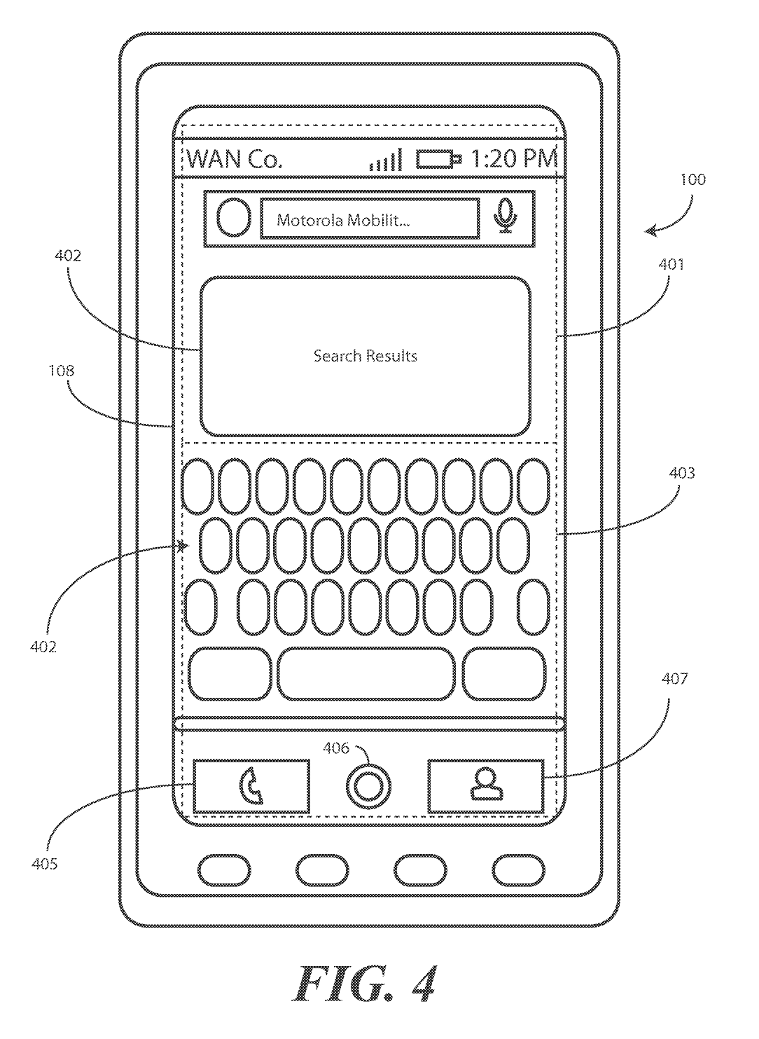

In yet another embodiment, step 331 can include determining a portion of the display 108 that is inoperable to receive user input due to damage. Step 332 can then include presenting user actuation targets on areas of the display 108 that are outside the portion determined in step 331. Step 332 can optionally include the omission of presenting data along the portion. For example, if the portion is so severely damaged that portions of the display layer 203 are also damaged, it may not be desirable to present any information along the damaged portion, be it user actuation targets or non-interactive information. Optional step 333 can include presenting non-interactive data or data other than user actuation targets along the portion where the damage is not so severe as to also damage the display layer 203. FIGS. 4-13 below will provide use case examples illustrating how methods and devices configured in accordance with one or more embodiments of the disclosure can perform the detection and presentation steps described above.

Turning first to FIG. 4, illustrated therein is the electronic device 100 in a first operational mode. Both user actuation targets and non-interactive presentation data are shown in the display 108. For example, a first portion 401 of the display 108 is showing search results 402 from an Internet search. Since these search results 402 are primarily intended for conveying information to the user, rather than being a dedicated user actuation target configured to cause a dedicated operation when touched by a user, the search results 402 are considered to be non-interactive presentation data. Note that the search results 402 may respond to touch input, however. For example a gesture input such as pinching or stretching the search results 402 may allow a user to zoom into or out of the search results. However, since this is a secondary function, with the primary function being to present the results of a search string, the search results may be considered to be non-interactive presentation data.

By contrast, a second portion 403 of the display 108 includes user actuation targets. For example, a first set of user actuation targets 404 is shown as a QWERTY keypad. By touching any one of the keys, a corresponding character is input. Other user actuation targets shown in the second portion 403 of the display 108 in FIG. 4 include a call user actuation target 405, a select user actuation target 406, and a videoconference user actuation target 407. These user actuation targets are illustrative only, as others will be obvious to those of ordinary skill in the art having the benefit of this disclosure.

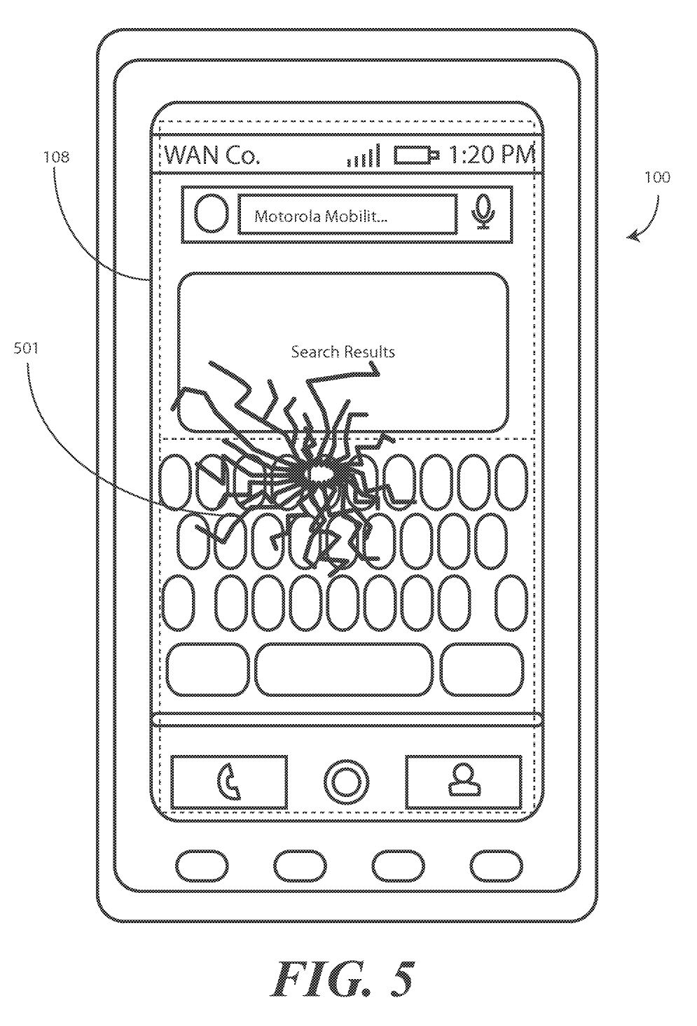

Turning now to FIG. 5, damage 501 has occurred along the display 108 of the electronic device 100. The illustrative damage 501 in FIG. 5 comprises a fracture to the fascia layer (201). As noted above, the damage detection module (304), working with the control circuit (301) of the electronic device 100, can be configured to detect this damage 501 and, in one embodiment, to determine the location of the damage 501 as well. FIGS. 6 and 8 illustrate two methods for performing this operation, respectively. Others will be obvious to those of ordinary skill in the art having the benefit of this disclosure.

Turning to FIG. 6, the damage detection module (304) is configured, at step 331 of method 330, to identify one or more electrode pairs 601,602 of the display 108 that are inoperable. In this illustration, electrode pairs 601,602 are inoperable due to the damage 501. However, electrode pairs defined by electrodes 603 and electrodes 604,605 are still operable. The damage detection module (304) can optionally determine a damage perimeter 606 by detecting which electrodes of electrodes 603 and electrodes 604,605 are still operable and are located closest to the damage 501.

Turning now to FIG. 7, the presentation adaptation module (305), working in tandem with the control circuit (301), is configured to present user actuation targets in areas of the display 108 that are complementary to portions where the damage 501 is located. As shown in FIG. 7, the set of user actuation targets 404 formed by the QWERTY keypad has been moved to a portion 701 of the display 108 that is complementary to the damaged portion 702. The call user actuation target 405, select user actuation target 406, and videoconference user actuation target 407 have all been left in another portion 703 of the display 108 that is complementary to the damaged portion 702 as well. The search entry information 704 has been relocated to the other portion 703 of the display 108 from its original location shown in FIG. 4 as well. This relocation of the user actuation targets allows the user (101) to employ the portions 701,703 of the display 108 that are operable to receive touch input for touch input.

In this illustrative embodiment, the presentation adaptation module (305) is presenting non-interactive presentation data, which is defined by the search results 402 in this example, in the damaged portion 702 of the display. This can be done in this example because the damage 501 is not sufficiently severe as to compromise either the visibility of the search results 402 or the operation of the display layer (203) and/or backlight layer (206).

Turning now to FIG. 8, illustrated therein is an alternate method by which the damage detection module (304) is configured, at step 331 of method 330, to determine a portion of the display 108 that is inoperable to receive user input due to the damage 501. Rather than identifying individual electrode pairs, in the embodiment of FIG. 8, the display 108 has been subdivided into a plurality of zones 801,802,803, etc. Accordingly, the damage detection module (304) can identify in which zones 801,802,803 the damage 501 is disposed. Note that the zones 801,802,803 can differ in size and shape. While shown as being uniform in the explanatory embodiment of FIG. 8, they can have different shapes and sizes as required by a particular design or application.

In one embodiment, each zone 801,802,803 corresponds to a group of electrode pairs. Accordingly, the damage detection module (304) can be configured to detect the damage 501 by determining which groups of electrode pairs are damaged. In one embodiment, if any electrode pair within a zone 801,802,803 is damaged, the damage detection module (304) is configured to deem that zone to be inoperable as a whole. For example, in FIG. 8 zones 804,805,806,807,808,809,810,811,812,813,814,815 all include damage. As such, in one embodiment the damage detection module (304) can designate each of these zones 804,805,806,807,808,809,810,811,812,813,814,815 as being unsuitable for receiving touch input. Moreover, the damage detection module (304) can define a damage perimeter 816 from the boundaries of these zones 804,805,806,807,808,809,810,811,812,813,814,815.

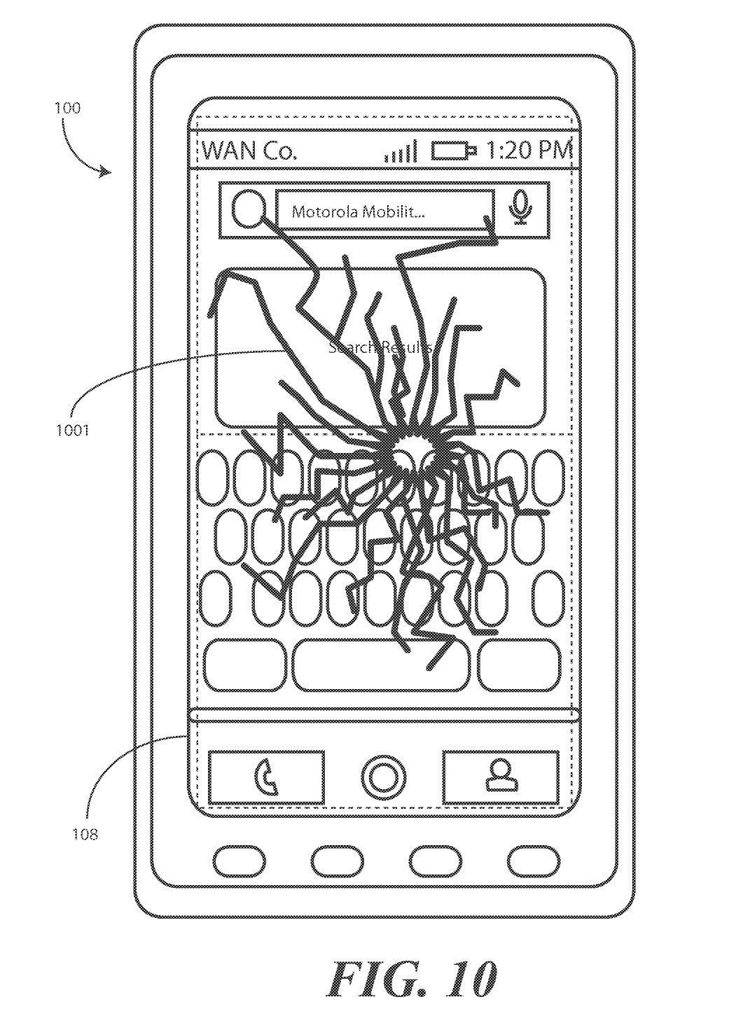

As shown in FIG. 9, the presentation adaptation module (305), working in tandem with the control circuit (301), is configured to present user actuation targets in areas of the display 108 that are complementary to portions where the damage 501 is located. As shown in FIG. 10, the set of user actuation targets 404 formed by the QWERTY keypad has been moved to a portion 901 of the display 108 that is complementary to the damaged portion 902. In this illustrative embodiment, the presentation adaptation module (305) has reconfigured the arrangement of these user actuation targets 404, however, prior to presenting them. As an illustration, the space bar 904 and control keys 905,906 have been separated from the QWERTY keys 907. This was reconfiguring was done so that the user actuation targets 404 could “fit” into available portions 901 of the display 108 suitable for receiving touch input. As will be appreciated by those of ordinary skill in the art having the benefit of this disclosure, the amount of reconfiguration necessary will be a function of the damage 501, the optionally determined damage perimeter, the display size, and other factors. Note that in this illustration, the reconfiguring has also included a 90-degree rotation of the call user actuation target 405, select user actuation target 406, and videoconference user actuation target 407, along with a translation of the same. This relocation and reconfiguration of the user actuation targets allows the user (101) to employ the portions 901 of the display 108 that are operable to receive touch input for touch input.

In one or more embodiments, there will not be sufficient room for each and every user actuation target to be presented in the portions 901 of the display 108 that are complementary to the damaged portion 902. Embodiments of the present invention accommodate for this by presenting only a portion of the actuation targets on the display 108 at a time, and allowing swiping or other gestures to page through additional ones of the actuation targets as needed. Other partial presentation methods will be obvious to those of ordinary skill in the art having the benefit of this disclosure as well. Additional methods for accommodating large damaged portions will be described below with reference to FIGS. 10-12.

In this illustrative embodiment, the presentation adaptation module (305) is presenting non-interactive presentation data, which is defined by the search results 402 in this example, in the damaged portion 902 of the display. This can be done in this example because the damage 501 is not sufficiently severe as to compromise either the visibility of the search results 402 or the operation of the display layer (203) and/or backlight layer (206).

To this point, the damage 501 has been light and has not affected the visibility of the non-interactive presentation data in the damaged portion 902. However, had the damage been more severe, the presentation adaptation module (305) may have presented no data in the damaged portion 902, thereby leaving the damaged portion 902 and presenting both the user actuation targets and the non-interactive presentation data in the portions 901 that are complementary to the damage 501.

Turning now to FIG. 10, illustrated therein is the electronic device 100 having received damage 1001 that is more severe than the damage (501) shown in FIG. 5. The damage 1001 of FIG. 10 covers far more of the display 108 than did the damage (501) of FIG. 5. As noted above, where this is the case, it may not be possible to provide all the user interaction targets that were presented on the display 108 prior to the damage 1001 in portions of the display 108 that are complementary to the damage 1001.

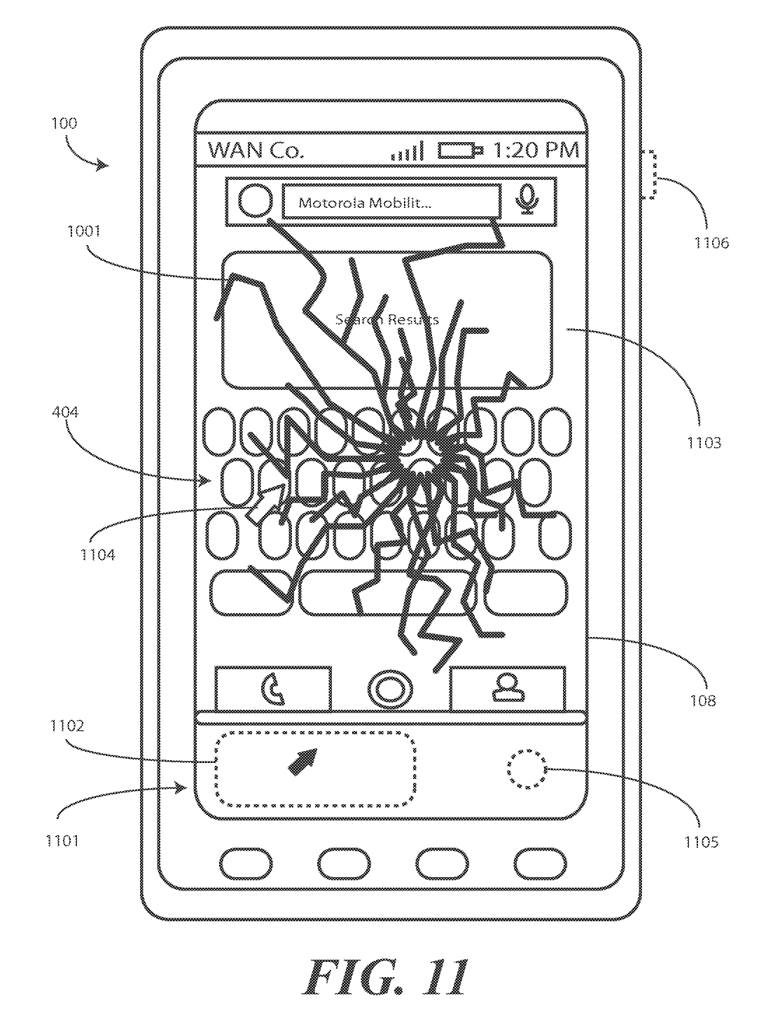

Turning now to FIG. 11, illustrated therein is one embodiment for allowing the electronic device 100 to still remain operational after severe damage 1001. As shown in FIG. 11, the portion 1101 of the display that is complementary to the damage 1001 is small and is disposed at a corner portion of the display 108. Where severe damage 1001 has occurred, small, corner portions will frequently remain operable due to the fact that the corner portions have reinforcing housing material disposed along two sides, thereby reinforcing the corner portions. Moreover, in one or more embodiments the touch sensor design can be further enhanced. For example, the thickness of the fascia layer or cover layer can be selectively thickened. Alternatively, the touch sensor layout can be thickened. Either serves to statistically increase the resistance to breakage. Accordingly, when breakage occurs, there is a higher likelihood that selected areas of the display are less prone to breakage and can thus be used for user actuation targets. These selected areas can be considered to be “preferred” areas for re-mapping user actuation areas in one or more embodiments. Still, regardless of where the damage 1001 is disposed, after the damage detection module (304) determines where the damage 1001 is disposed, in one embodiment the presentation adaptation module (305) is configured to present user actuation targets in complementary portions 1101 of the display 108 by presenting a track pad 1102 in the complementary portion 1101.

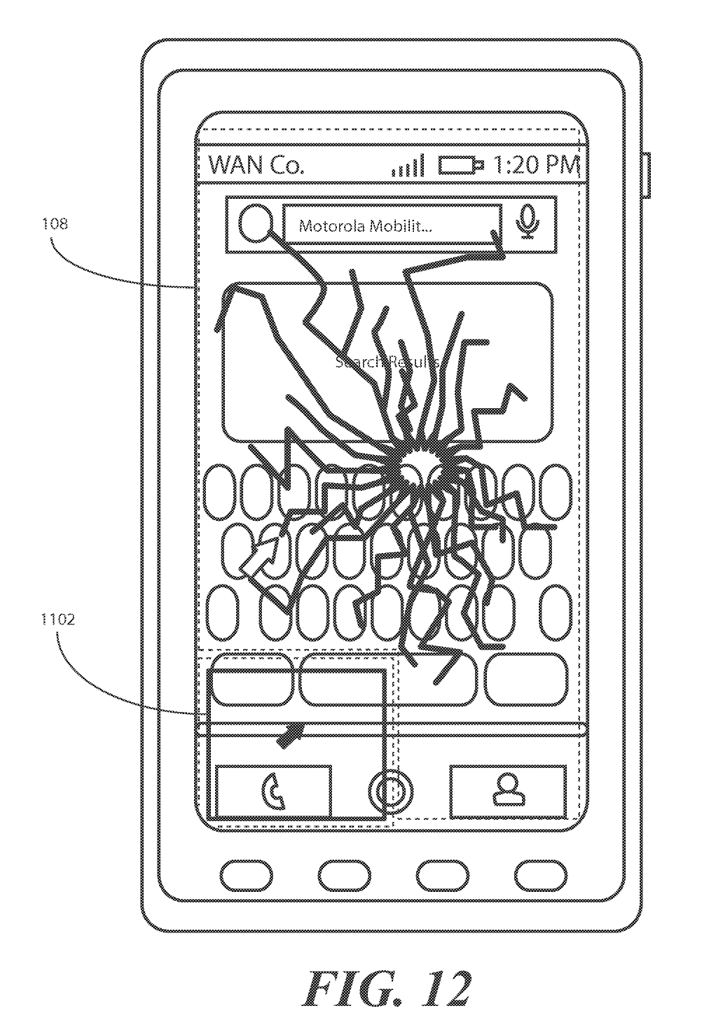

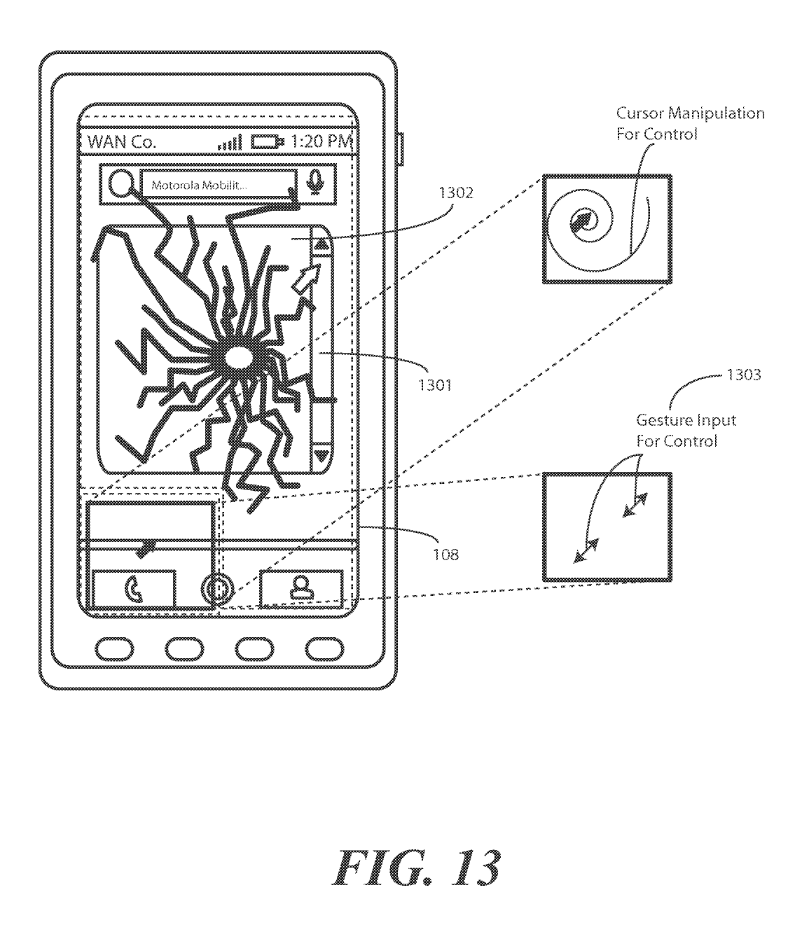

The use of a track pad 1102 can be beneficial because it allows user actuation targets 404 to be presented in the damaged portions 1103 of the display 108. A user can then manipulate the track pad 1102 to move a cursor 1104 to the user actuation targets 404 being presented in the damaged portion 1103. The user can then use a select user actuation target 1105, where there is sufficient room in the complementary portions 1101 of the display 108, or optionally a physical key 1106 of the electronic device 100 to select a desired user actuation target being presented within the damaged portion 1103. Accordingly, the user (101) can still use the damaged portion 1103 for user input even though the damaged portion 1103 is not operable for receiving touch input. As shown in FIG. 12, the track pad 1102 can overlay presentation data so that more of the display 108 may be used to communicate information to the user (101). As shown in FIG. 13, the track pad 1102 can be used to control any user input feature suitable for presentation on the display. One example of an alternative user input feature is the scrolling bar 1301 of a web browser 1302. Note that gesture input 1303, such as pinching and reverse pinching, can be applied to the track pad 1102 as well. In one or more embodiments, the track pad 1102 of embodiments of the disclosure can receive any gesture input that a traditional track pad can receive to control the presentation data on the display 108.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method, in an electronic device, comprising:
detecting, with a control circuit of the electronic device, a damaged portion of a touch sensitive display; and
presenting user actuation targets in areas of the touch sensitive display that are complementary to the damaged portion.

2. The method of claim 1, further comprising presenting at least some non-interactive presentation data in the damaged portion.

3. The method of claim 1, further comprising reconfiguring an arrangement of the user actuation targets prior to the presenting.

4. The method of claim 1, the detecting comprising identifying one or more electrode pairs of the touch sensitive display that are inoperable to detect touch input.

5. The method of claim 1, further comprising subdividing areas of the touch sensitive display into zones, the detecting comprising identifying in which zones the damaged portion is disposed.

6. The method of claim 1, the areas of the touch sensitive display that are complementary to the damaged portion comprising corner portions of the touch sensitive display.

7. The method of claim 1, the user actuation targets comprising a track pad.

8. The method of claim 7, the user actuation targets further comprising a selection actuation target.

9. The method of claim 7, further comprising receiving selection input from one or more physical keys of the electronic device.

10. The method of claim 7, the track pad overlaying non-interactive presentation data.

11. An electronic device, comprising:
a touch sensitive display;
a control circuit operable with the touch sensitive display to determine a portion of the touch sensitive display that is inoperable to receive user input due to damage and to present user actuation targets on areas of the touch sensitive display outside the portion.

12. The electronic device of claim 11, the touch sensitive display comprising a capacitive touch sensor.

13. The electronic device of claim 12, the capacitive touch sensor comprising a plurality of electrode pairs disposed along a substrate.

14. The electronic device of claim 13, the control circuit to determine the portion by identifying inoperable individual electrode pairs.

15. The electronic device of claim 13, the control circuit to determine the portion by identifying inoperable groups of electrode pairs.

16. The electronic device of claim 11, the control circuit to omit presenting data along the portion.

17. The electronic device of claim 11, the control circuit to present data other than the user actuation targets along the portion.

18. The electronic device of claim 11, further comprising a fascia, the damage comprising a fracture of the fascia.

19. A method, comprising:
detecting, with a control circuit, damage to a touch sensitive user input of an electronic device;
determining a damage perimeter circumscribing the damage; and
presenting user actuation targets on the touch sensitive user input only outside the damage perimeter.

20. The method of claim 19, further comprising presenting at least some non-interactive presentation data within the damage perimeter.
